(19) United States
(12) Patent Application Publication
(10) Pub. No.: US 2023/0332764 A1
(43) Pub. Date: Oct. 19, 2023

(54) METHOD AND APPARATUS, ELECTRONIC DEVICE AND STORAGE MEDIUM FOR CONTROLLING FLASHING COLOR LAMPS

(71) Applicant: Coco Tongman Technology (Shenzhen) Co., Ltd, Shenzhen (CN)

(72) Inventor: Lijun Tao, Shenzhen (CN)

(21) Appl. No.: 18/120,370

(22) Filed: Mar. 11, 2023

(30) Foreign Application Priority Data
Mar. 11, 2022 (CN) 202210235569.0

(51) Int. Cl. F21V 23/04; F21V 23/00

(52) U.S. Cl. CPC F21V 23/0407; F21V 23/003; F21V 23/0435; F21V 23/0457; F21Y 2115/10

(57) ABSTRACT

The present invention discloses a method for controlling flashing color lamps, which comprises the following steps: establishing a virtual model corresponding to a physical layout form, obtaining a control instruction for triggering the virtual model so as to control the flashing color lamps to do actions matching the control instruction, and a flashing color lamp apparatus, an electronic device and a storage medium for implementing the method. Users can control the flashing color lamps individually, which enhances the use interest of the flashing color lamps and meets various control requirements of users.

### TECHNICAL FIELD

The present invention relates to the technical field of lamp control, in particular to a method, an apparatus, an electronic device and a storage medium for controlling flashing color lamps.

### BACKGROUND

Different from the traditional light source, LED light source is a low-voltage microelectronic product, which successfully integrates advanced science and technology such as computer technology, network communication technology, image processing technology and embedded control technology. Therefore, applying LED light source to decorative lamps can make decorative lamps highly intelligent and produce various ever-changing and unexpected effects, and LED flashing color lamps are one of them.

The flashing lamp is a new type of LED lamp, which adjusts the color and brightness of the lamp through the controller. The main structure is that a plurality of LED lamp bead chips are packaged in various forms and connected with the driving circuit respectively, and the controller can control one or more of the chips to achieve the flashing effect. At present, the flashing color lamps are mostly used to decorate the Christmas tree or the wall. The flashing color lamps are randomly arranged on the Christmas tree or the wall, and then controlled by the controller to produce different lighting effects.

However, the control function of the flashing color lamps in the prior art is too simple, and users can only control the lighting effect of the flashing color lamps according to the preset program. For example, the American invention patent with the publication number of US20210278069A1 discloses a variable multi-color LED light string and a controller for artificial trees, including a white light emitting diode (LED) light string and a variable color LED light string. The color-changeable LED light string may employ LED lamps having embedded Red, Green, and Blue (RGB) LEDs. The RGB LED lamps may include an embedded integrated circuit (IC) configured to communicate with and control the energizing of each of the corresponding RGB LEDs to create a multitude of colors and color combinations that can vary with time to create a light show. An electronic controller in communication with the LED lamps may allow a user to select the mode for the light show and further may provide a periodic reset signal to restart or re-synchronize the light show.

With this solution, users can only switch the lighting effect of the flashing color lamps according to the preset lighting program. In situations where lighting needs to be coordinated with the environment, such as lighting shows or festivals, the number of preset lighting programs is limited, resulting in a single lighting effect of the flashing color lamps. Users want to make personalized lighting effects of the flashing color lamps, so they can only set the programs in advance, and setting the lighting programs involves complicated programming, which is very difficult for ordinary users and increases the user’s use threshold.

Based on the above contents, it is necessary to provide a method for controlling flashing color lamps that can change the lighting effect in real time according to the user’s needs and provide personalized customization. The method for controlling flashing color lamps can preview the lighting effect of flashing color lamps, and at the same time, it can give real-time lighting feedback to the instructions sent by customers, and the method for controlling flashing color lamps is simple, convenient and easy to use, which meets various control requirements of users.

### SUMMARY

The present invention provides a method for controlling flashing color lamps, which includes the following steps: establishing a first virtual model according to a physical layout form of the flashing color lamps to be controlled, wherein the first virtual model is configured for controlling the flashing color lamps to flash; wherein the method further comprises:
a, presetting a color sequence for the first virtual model, and generating a flashing color lamp control instruction according to the color sequence, wherein the flashing color lamp control instruction is configured for controlling the flashing color lamps to flash in a preset flashing frame;
b, acquiring a real-time flashing image of the flashing color lamps when flashing in the preset flashing frame to generate a real-time flashing picture of the flashing color lamps;
c, extracting an actual flashing color in the real-time flashing picture of the flashing color lamps to generate a real-time flash frequency color sequence of the flashing color lamps;
d, generating actual spatial positions of the flashing color lamps and establishing a second virtual model based on the preset color sequence and the real-time flash frequency color sequence;
e, correcting the first virtual model with the second virtual model, so that the spatial positions of the virtual flashing color lamps in the first virtual model correspond to the spatial positions of the flashing color lamps in the physical layout form.

The present invention also provides an apparatus for controlling flashing color lamps, an electronic device and a storage medium, wherein the apparatus for controlling flashing color lamps includes a model establishing module and a flashing color lamp control module; the electronic device includes a processor and a memory; a computer program is stored on the storage medium; and the flashing color lamp control device, the electronic device and the storage medium can realize a flashing color lamp control method, which comprises the following steps: establishing a first virtual model according to a physical layout form of the flashing color lamps to be controlled; acquiring the flashing color lamp control instruction which triggers the first virtual model and sending the flashing color lamp control instruction to the flashing color lamps to be controlled, wherein the flashing color lamp control instruction is configured for controlling the flashing color lamps to be controlled to do actions matched with the flashing color lamp control instruction.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is an application environment diagram of a control method for flashing color lamps provided by an embodiment of the present invention;

FIG. 2 is a schematic flow chart of the control method for flashing color lamps provided by the embodiment of the present invention;

FIG. 3 is a flow diagram of establishing a first virtual model according to an embodiment of the present invention;

FIG. 4 is a schematic flow diagram of generating a second control instruction provided by an embodiment of the present invention;

FIG. 5 is a schematic flow diagram of generating a third control instruction provided by an embodiment of the present invention;

FIG. 6 is a structural block diagram of an apparatus for controlling flashing color lamps provided by an embodiment of the present invention;

FIG. 7 is a structural block diagram of a model establishing module provided by an embodiment of the present invention;

FIG. 8 is a structural block diagram of a method for controlling flashing color lamps provided by another embodiment of the present invention;

FIG. 9 is a structural block diagram of the method for controlling flashing color lamps provided by the third embodiment of the present invention;

FIG. 10 is an intemal structure diagram of an electronic device provided by an embodiment of the present invention.

### DESCRIPTION OF EMBODIMENTS

In the following description, specific details, such as specific system structure and technology, are set forth for the purpose of explanation rather than limitation, so as to thoroughly understand the embodiments of the application. However, it will be apparent to one skilled in the art that the present application may be practiced in other embodiments without these specific details. In other cases, detailed descriptions of well-known systems, devices, circuits and methods are omitted so as not to obscure the description of this application with unnecessary details.

It should be understood that that term “comprise”, when used in the specification and append claims, indicates the presence of described feature, integers, steps, operations, elements and/or components, but does not exclude the presence or addition of one or more other features, integers, steps, operations, elements, components and/or groups thereof.

It should also be understood that the term “and/or” used in this specification and the appended claims refers to any combination and all possible combinations of one or more of the associated listed items, and includes these combinations.

As used in the specification of this application and the appended claims, the term “if” can be interpreted as “when” or “once” or “in response to determination” or “in response to detection” depending on the context. Similarly, the phrases “if determined” or “if [described condition or event] is detected” can be interpreted as meaning “once determined” or “in response to determination” or “once [described condition or event] is detected” or “in response to detection [described condition or event]” depending on the context.

In addition, in the description of this application and the appended claims, the terms “first”, “second” and “third” are only used to distinguish descriptions, and cannot be understood as indicating or implying relative importance.

Reference to “one embodiment” or “some embodiments” and the like described in the specification of this application means that a specific feature, structure or characteristic described in connection with this embodiment is included in one or more embodiments of this application. Thus, the phrases “in one embodiment”, “in some embodiments”, “in other embodiments” and “in still other embodiments” appearing in different places in this specification do not necessarily all refer to the same embodiment, but mean “one or more but not all embodiments” unless otherwise emphasized. The terms “include”, “including”, “having” and their variations all mean “including but not limited to” unless otherwise specifically emphasized.

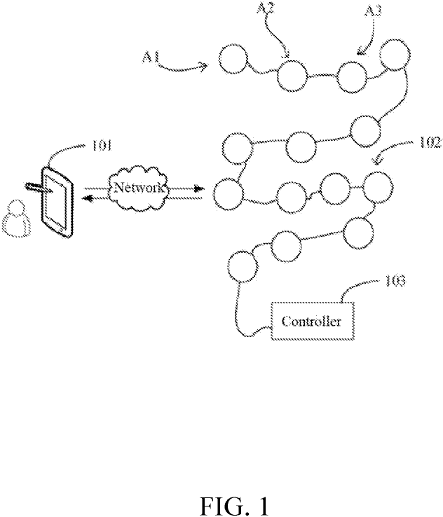

The method for controlling the flashing color lamps provided by the embodiment of the application can be applied to the application environment as shown in FIG. 1, wherein the terminal 101 communicates with the flashing color lamps 102 to be controlled through a network, and the terminal 101 establishes a first virtual model according to the physical layout form of the flashing color lamps to be controlled; wherein the spatial positions of the virtual flashing color lamps in the first virtual model fully correspond to the spatial positions of the flashing color lamps to be controlled in the physical layout form; the number of the control wires of virtual flashing color lamps in the first virtual model is not less than the number of flashing color lamps to be controlled, so as to realize one-to-one control of each flashing color lamp. Then, the user can trigger the first virtual model on the terminal 101, and the terminal 101 obtains the flashing color lamp control instruction that triggers the first virtual model and sends it to the flashing color lamp to be controlled; the flashing color lamp control instruction is used to control the flashing color lamp to be controlled to do actions matched with the flashing color lamp control instruction.

The terminal 101 can be, but is not limited to, various smart phones, tablet computers, portable wearable devices, personal computers and notebook computers.

In one embodiment of the present invention, the flashing color lamps 102 to be controlled are connected with the controller 103, which is in communication with the flashing color lamps 102 to be controlled, and the terminal 101 is in communication with the flashing color lamps 102 to be controlled through communication with the controller 103. Specifically, the controller 103 has its own network, by which the communication connection between the terminal 101 and the flashing color lamp 102 to be controlled is realized.

In another embodiment of the present invention, both the controller 103 and the terminal 101 are connected to the same network, that is, they are in the same local area network, thereby realizing the communication between the terminal 101 and the flashing color lamps 102 to be controlled.

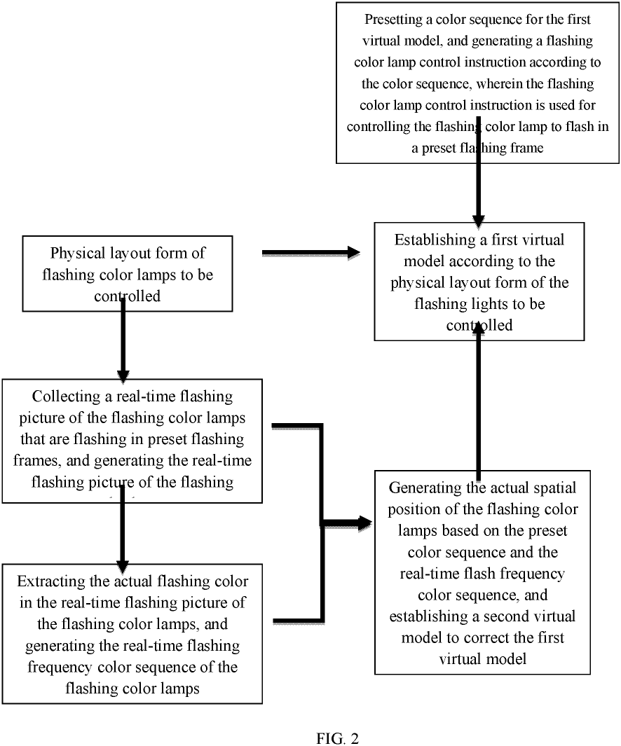

As shown in FIG. 2, a method for controlling flashing color lamps provided by the present invention includes:
S100, establishing a first virtual model according to the physical layout form of the flashing color lamps to be controlled, wherein the virtual flashing color lamps in the first virtual model correspond to the flashing color lamps to be controlled in the physical layout form one by one;
S200: acquiring a flashing color lamp control instruction that triggers the first virtual model, and sending the flashing color lamp control instruction to the flashing color lamp to be controlled, wherein the flashing color lamp control instruction is used for controlling the flashing color lamps to be controlled to do actions matched with the flashing color lamp control instruction.

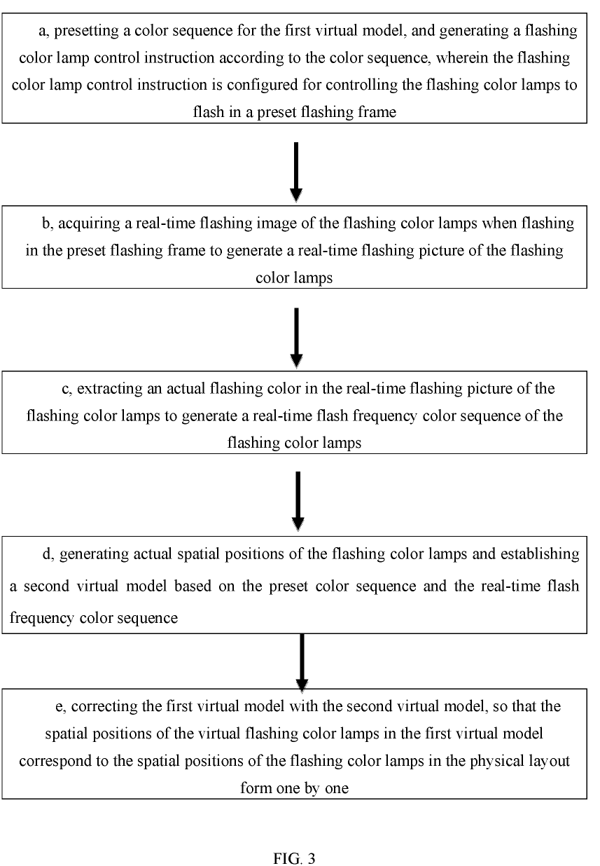

As shown in FIG. 3, as a preferred embodiment of the present invention, in S100, a first virtual model is established according to the physical layout form of the flashing color lamps to be controlled, and the first virtual model is used to control the flashing of the flashing color lamps, and the method further includes:
a, presetting a color sequence for the first virtual model, and generating a flashing color lamp control instruction according to the color sequence, wherein the flashing color lamp control instruction is configured for controlling the flashing color lamps to flash in a preset flashing frame;
b, acquiring a real-time flashing image of the flashing color lamps when flashing in the preset flashing frame to generate a real-time flashing picture of the flashing color lamps;
c, extracting an actual flashing color in the real-time flashing picture of the flashing color lamps to generate a real-time flash frequency color sequence of the flashing color lamps;
d, generating actual spatial positions of the flashing color lamps and establishing a second virtual model based on the preset color sequence and the real-time flash frequency color sequence;
e, correcting the first virtual model with the second virtual model, so that the spatial positions of the virtual flashing color lamps in the first virtual model correspond to the spatial positions of the flashing color lamps in the physical layout form one by one.

Specifically, in S100, the number of flashing color lamps to be controlled is one or more. When the number of flashing color lamps to be controlled is multiple, the flashing color lamps to be controlled are electrically connected in turn. In actual use, the flashing color lamps to be controlled will be arranged on different carriers according to actual needs, such as on a wall or on decorations such as a Christmas tree. At this time, the actual form of the flashing color lamps to be controlled after being arranged on different carriers as required is the physical layout form.

Due to the different needs of users, there are many types of entity layout forms. In S100, the first virtual model is established according to the entity layout form, and the first virtual model is matched with the entity layout form, and the matching virtual model is established according to the usage conditions of different users, so as to realize personalized customization. Compared with the inherent single model control mode in the prior art, based on the corresponding relationship between the established entity layout form and the first virtual model in S100, the user’s use needs and use pleasure are greatly satisfied.

In S200, because the virtual flashing color lamps in the first virtual model correspond to the flashing color lamps to be controlled in the physical layout one by one, when the virtual flashing color lamps in the first virtual model are controlled, the flashing color lamps to be controlled corresponding to the virtual flashing color lamps also emit light correspondingly, that is, after the flashing color lamps control instruction is sent to the flashing color lamps to be controlled, the flashing color lamps control instruction is used to control the flashing color lamps to be controlled to do actions matched with the flashing color lamps control instructions. If the user randomly slides to trigger the lighting of the first and third virtual flashing color lamps in the first virtual model, the first and third flashing color lamps to be controlled in the corresponding physical layout form also emit light correspondingly, thus realizing the random control of the flashing color lamps to be controlled.

According to the control method of the flashing color lamps provided by the present invention,

a first virtual model is firstly established through the physical layout form of the flashing color lamps to be controlled, then the flashing color lamps control instruction that the user triggers the first virtual model is obtained and sent to the flashing color lamps to be controlled; the flashing color lamps control instruction is used for controlling the flashing color lamps to do actions matched with the flashing color lamps control instruction. A camera is used to identify the flashing frequency and color sequence of each LED lamp in the corresponding time period, so as to identify and calculate the spatial coordinates of the color lamps, and establish a spatial model consistent with the real scene, which improves the use interest and is convenient to control, and meets the various control needs of users for the flashing color lamps.

As a preferred embodiment of the present invention, the color sequence in the method a is preset based on the flashing color lamps to be controlled, such as controlling the flashing color lamps to be controlled in advance. In this embodiment, as shown in FIG. 1, for the flashing color lamp A1 to be controlled, the color sequence can be preset as follows: blue, blue, red, green, red, blue; for that flashing color lamp A2 to be controlled, preset color sequence are blue, blue, red, green, red and red; For the flashing color lamp A3 to be controlled, the preset color sequence is red, blue, red, green, red and blue; other flashing color lamps to be controlled are randomly set in sequence to ensure the uniqueness of the color sequence of each lamp bead.

It should be noted that the preset color sequences of A1, A2 and A3 introduced in the above embodiment are only one in the implementation process of this embodiment, and other color sequences can also be used for flashing, as long as the color sequence of each LED lamp in the flashing process is guaranteed to be unique.

Before controlling the flashing of the flashing color lamps, the user triggers the terminal 101 to start the modeling. After the terminal 101 obtains the user’s triggering operation, it then sends a flashing control instruction to the flashing color lamps to be controlled in the physical layout form, and based on the flashing control instruction, controls the flashing color lamps to be controlled to flash in a flashing way matching the flashing control instruction.

Taking the color sequence of the above-mentioned flashing color lamps A1-A3 to be controlled as an example, there are two control methods for each flashing color lamp to be controlled. One is to control and flash the flashing color lamps to be controlled in turn, that is, to control the flashing color lamps A1 to be controlled first, so that the flashing color lamps A1 to be controlled will flash according to their color sequence, and similarly, other flashing color lamps to be controlled will also flash according to the corresponding color sequence. At this time, in this control mode, the color sequence is the real-time color flashing sequence, and the flashing control instruction is generated according to the real-time color flashing sequence, so that the flashing color lamps to be controlled are controlled to flash in a preset flashing frame based on the flashing control instruction, which lays a data support for the subsequent acquisition of the actual spatial position.

In the embodiment of the present invention, the preset flashing frame is the number of times that the flashing color lamp to be controlled flashes.

In another embodiment, in order to improve the modeling efficiency, another control method is adopted. Specifically, all the flashing color lamps to be controlled are controlled at the same time during a preset flashing frame. Taking the color sequence of the flashing color lamps A1-A3 to be controlled as an example, at this time, in the first preset flashing frame, the real-time color flashing sequence is the first color sequence in the color sequence of flashing lamps A1-A3 to be controlled, namely blue, blue and red.

In the second preset flashing frame, the real-time color flashing sequence is the second color sequence in the color sequence of the flashing color lamps A1-A3 to be controlled, namely blue, blue and blue; real-time color flashing sequences corresponding to other preset flashing frames are generated according to the above generation mode, so that the number of colors contained in the real-time color flashing sequence is the same as that of the preset flashing frames, and the flashing of all flashing color lamps to be controlled is controlled at the same time every time the flashing frames are preset, so that efficient and rapid modeling is realized, and the modeling efficiency is improved while ensuring the modeling accuracy.

In the method b, when the flashing color lamps to be controlled are flashing, the real-time flashing images of the flashing color lamps to be controlled are collected when the flashing color lamps are flashing in a flashing mode matched with the flashing control instruction, so as to realize the positioning of the flashing color lamps to be controlled.

That is, when the first virtual model is established, the flashing color lamps to be controlled need to be positioned, so as to meet the one-to-one correspondence between the virtual flashing color lamps and the flashing color lamps to be controlled. In this method, the flashing color lamps to be controlled are controlled based on the flashing control instruction first, and then the flashing images of the flashing color lamps are collected to realize the positioning of the flashing color lamps.

Specifically, the real-time flashing image of the flashing color lamps can be a video or a picture, and the positioning can be realized by extracting the real-time flash frequency color of the flashing color lamps to be controlled from the video or the image, wherein the flashing color lamps to be controlled flash with a preset flashing frame; when the flashing color lamps to be controlled flash with a preset flashing frame, they correspond to a real-time flashing picture of the flashing color lamps, and the preset flashing frame is adjusted according to the physical layout form of the flashing color lamps; different flashing color lamps flash with different preset flashing frames correspond to real-time flashing pictures of the flashing color lamps in different time periods.

As shown in FIG. 1, if the flashing color lamp A1 to be controlled is controlled to flash based on the flashing control instruction, and other flashing color lamps to be controlled are not lit, then only the flashing color lamp A1 to be controlled will flash in the real-time flashing pictures of the flashing color lamps collected at this time, so that the actual position of the flashing color lamp A1 to be controlled can be positioned; the flashing color lamp A1 to be controlled can be controlled to flash or always light based on the flashing control instruction. After the positioning of the flashing color lamp A1 to be controlled is obtained, the other flashing color lamps to be controlled can be controlled in turn, and the real-time flashing pictures of the flashing color lamps can be collected at the same time, thereby completing the positioning of all the flashing lamps to be controlled.

Alternatively, in order to improve the accuracy of positioning, a flashing color lamp to be controlled can be controlled in multiple times, for example keep lighting and then flashing, and then accurate position positioning is realized according to real-time flashing pictures of the flashing color lamps flashing simultaneously.

In method c, the same flashing color lamps to be controlled are extracted from the real-time flashing images of all flashing color lamps, and the positioning of the flashing color lamps to be controlled is realized.

Specifically, assuming that each color sequence in method a contains M colors, the controller 103 sends the first color combination in the sequence, and synchronizes the flashing color lamps 102 to be controlled to display the corresponding color combination; the terminal 101 collects the current real-time flashing picture, repeats the above method, sends 1 to M color combinations respectively, and obtains the corresponding M real-time flashing pictures, and extracts the colors in the m real-time flashing pictures of the flashing color lamps, that is, the actual flashing colors of the flashing color lamps. Because of the uniqueness of the color sequence, the serial number of the lamp bead corresponding to the current coordinate point can be identified, so that the coordinate position of each identifiable lamp bead can be obtained. Using the coordinate position of the lamp bead, the 2D plane model of the whole flashing color lamps to be controlled can be generated. At this time, the 2D model can be used for graffiti control and special effect display of the lamp bead.

Each flashing color lamp has a real-time flashing color and spatial position in the real-time flashing pictures of the flashing color lamps, the actual flashing colors of the flashing color lamps to be controlled in a plurality of flashing pictures are combined in turn, and a real-time flash frequency color sequence of the flashing color lamps is generated according to the real-time flashing colors and spatial positions of the flashing color lamps in different periods, wherein each flashing color lamp to be controlled corresponds to a real-time flash frequency color sequence.

In method d, based on the flashing control instruction, the flashing color lamps to be controlled are controlled to flash according to their respective corresponding color sequences, and then the real-time flashing image, real-time flashing picture and real-time flash frequency color sequence of the flashing color lamps to be controlled are obtained in turn, and the real-time flash frequency color sequence is compared with each color sequence. When they match, a second virtual model can be established according to the spatial position of the flashing color lamps to be controlled corresponding to the real-time flash frequency color sequence in the physical layout form. In the establishment of the 3D model, the 3D model of the flashing color lamps to be controlled is obtained by shooting around the space scene where the flashing color lamps to be controlled are located at different positions and angles, and methods a, b and c are repeated, so as to obtain a plurality of groups of 2D plane models of the flashing color lamps to be controlled in different coordinate systems, and finally the 3D space model of the flashing color lamps to be controlled is calculated through the calculation of a plurality of different 2D plane models.

In method e, the first virtual model is corrected by the actual spatial position of the second virtual model, so that the spatial position of the virtual flashing color lamps in the first virtual model corresponds to the spatial position of the flashing color lamps in the physical layout form, and the virtual modeling of the physical layout form of the flashing color lamps to be controlled is completed at this time.

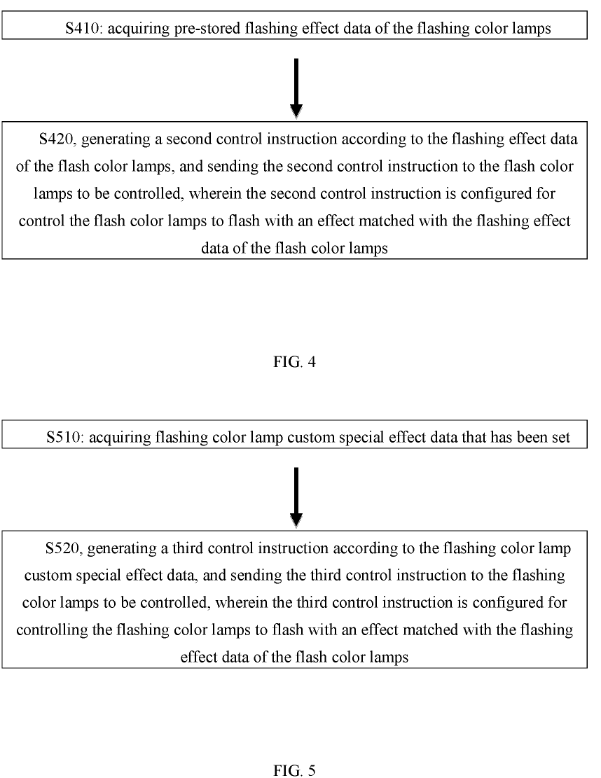

In another embodiment of the present invention, as shown in FIG. 4, S100: a first virtual model is established according to the physical layout form of the flashing color lamps to be controlled; then it further includes:
S410: acquiring pre-stored flashing effect data of the flashing color lamps;
S420: generating a second control instruction according to the flashing effect data of the flash color lamps, and sending the second control instruction to the flash color lamps to be controlled, wherein the second control instruction is configured for control the flash color lamps to flash with an effect matched with the flashing effect data of the flash color lamps.

Specifically, the flashing effect data of the flashing color lamps are pre-stored, specifically a variety of animation effects, that is, by establishing a variety of animation effects in the terminal 101, corresponding effects can be played based on the second control instruction according to the physical layout form of the flashing color lamps to be controlled, so as to realize fast playing and greatly enhance the user experience.

Alternatively, the flashing effect data of the flashing color lamps can be downloaded through the network and pre-stored in the controller 103, and the off-line control of the special effects of the flashing color lamps to be controlled can be realized through the terminal 101 or through the infrared remote controller, so as to meet the playing requirements without the network.

In another embodiment of the present invention, as shown in FIG. 5, S100: a first virtual model is established according to the physical layout form of the flashing color lamps to be controlled, and then it further includes:
S510: acquiring flashing color lamp custom special effect data that has been set;
S520: generating a third control instruction according to the flashing color lamp custom special effect data, and sending the third control instruction to the flashing color lamps to be controlled, wherein the third control instruction is configured for controlling the flashing color lamps to flash with an effect matched with the flashing effect data of the flash color lamps.

Specifically, the custom special effect data of the flashing color lamps triggers the first virtual model at will according to the user’s own requirements, so as to set the special effect data of the custom flashing color lamps, and control the flashing color lamps to be controlled based on the third control instruction, so as to meet the custom control requirements of the flashing color lamps.

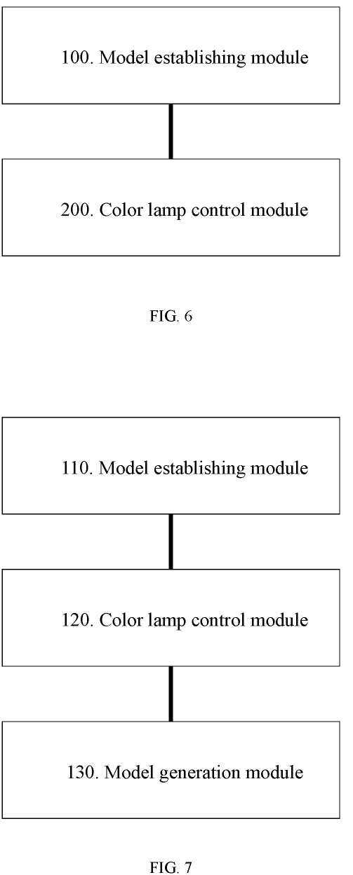

In another embodiment of the present invention, as shown in FIG. 6, an apparatus for controlling flashing color lamps is provided, which is applied to an electronic device, and the apparatus for controlling flashing color lamps includes the following modules:
a model establishing module 100 used for establishing a first virtual model according to a physical layout form of the flashing color lamps to be controlled, wherein the first virtual model is configured for controlling the flashing color lamps to flash, including: a, presetting a color sequence for the first virtual model, and generating a flashing color lamp control instruction according to the color sequence, wherein the flashing color lamp control instruction is configured for controlling the flashing color lamps to flash in a preset flashing frame; b, acquiring a real-time flashing image of the flashing color lamps when flashing in the preset flashing frame to generate a real-time flashing picture of the flashing color lamps; c, extracting an actual flashing color in the real-time flashing picture of the flashing color lamps to generate a real-time flash frequency color sequence of the flashing color lamps; d, generating actual spatial positions of the flashing color lamps and establishing a second virtual model based on the preset color sequence and the real-time flash frequency color sequence; e, correcting the first virtual model with the second virtual model, so that the spatial positions of the virtual flashing color lamps in the first virtual model correspond to the spatial positions of the flashing color lamps in the physical layout form one by one;
a flashing color lamp control module used for acquiring the flashing color lamp control instruction which triggers the first virtual model and sending the flashing color lamp control instruction to the flashing color lamps to be controlled, wherein the flashing color lamp control instruction is configured for controlling the flashing color lamps to be controlled to do actions matched with the flashing color lamp control instruction.

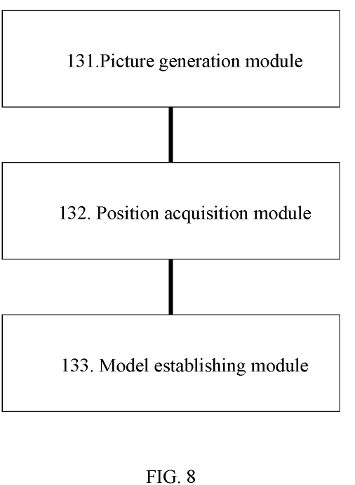

In another embodiment of the present invention, as shown in FIG. 7, the model establishing module includes the following modules:
an instruction sending module 110 used for sending a flashing control instruction to the flashing color lamps to be controlled in the physical layout form, wherein the flashing control instruction is used to control the flashing color lamps to be controlled to flash in a flashing mode matched with the flashing control instruction;
a flashing control module 120 used for acquiring a real-time flashing image of the flashing color lamps when the flashing color lamps to be controlled are flashing in a flashing mode matched with the flashing control instruction;
a model generation module 130 used for establishing a first virtual model according to the flashing images of the flashing color lamps.

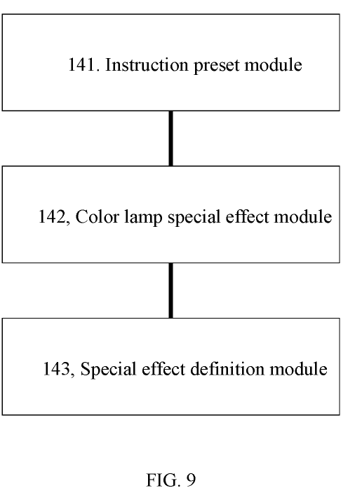

In another embodiment of the present invention, as shown in FIG. 8, the model generation module 130 further includes the following modules:
a picture generation module 131 used for generating a flashing color lamp real-time picture of the flashing color lamp to be controlled according to the flashing color lamp real-time image, wherein the flashing color lamp to be controlled flashes with a preset flashing frame, and when the flashing color lamp to be controlled flashes with a preset flashing frame, it corresponds to a flashing color lamp flashing picture;
a position acquisition module 132 use for generating the actual spatial position of each flashing color lamp to be controlled according to the real-time flashing picture of each flashing color lamp;
a model establishing module 133 used for establishing a first virtual model according to each actual spatial position.

In another embodiment of the present invention, the position acquisition module 132 is further used to extract the actual flashing colors of the flashing color lamps to be controlled in each flashing color lamp real-time flashing picture according to each flashing color lamp real-time flashing picture, wherein one flashing color lamp to be controlled has an actual flashing color in one flashing color lamp real-time flashing picture; according to the actual flashing colors of the flashing color lamps to be controlled, real-time flash frequency color sequences of the flashing color lamps to be controlled are generated respectively, wherein one flashing color lamp to be controlled correspondingly has a real-time flash frequency color sequence; the actual spatial position of each flashing color lamp to be controlled is generated based on the real-time flash frequency color sequence and the preset color sequence of each flashing color lamp to be controlled, wherein each flashing color lamp to be controlled corresponds to a preset color sequence.

In another embodiment of the present invention, as shown in FIG. 9, the apparatus for controlling flashing color lamps further includes an instruction preset module 141, which is used for presetting color sequence according to each flashing color lamp to be controlled, wherein one flashing color lamp to be controlled corresponds to one color sequence; generating a real-time color flashing sequence according to each color sequence; generating a flashing control instruction

according to that real-time color flashing sequence, wherein the flashing control instruction is used for controlling the flashing color lamp to be controlled to flash in a preset flashing frame.

In another embodiment of the present invention, the flashing color lamp control apparatus further includes a flashing color lamp special effect module 142, wherein the flashing color lamp special effect module 142 is used for acquiring pre-stored flashing color lamp effect data; generating a second control instruction according to the flashing color lamp flashing effect data, and sending the second control instruction to the flashing color lamp to be controlled, wherein the second control instruction is used for controlling the flashing color lamp to flash with an effect matched with the flashing color lamp flashing effect data.

In another embodiment of the present invention, the flashing color lamp control apparatus further includes a special effect definition module 143, which is used for: acquiring the set custom flashing color lamp special effect data; generating a third control instruction according to the custom flashing color lamp special effect data, and sending the third control instruction to the flashing color lamp to be controlled, wherein the third control instruction is used for controlling the flashing color lamp to flash with an effect matched with the flashing color lamp flashing effect data.

Each module in the above-mentioned flashing color lamp control device can be realized in whole or in part by software, hardware and their combinations. The above modules can be embedded in or independent of the processor in the electronic device in the form of hardware, and can also be stored in the memory in the electronic device in the form of software, so that the processor can call and execute the operations corresponding to the above modules.

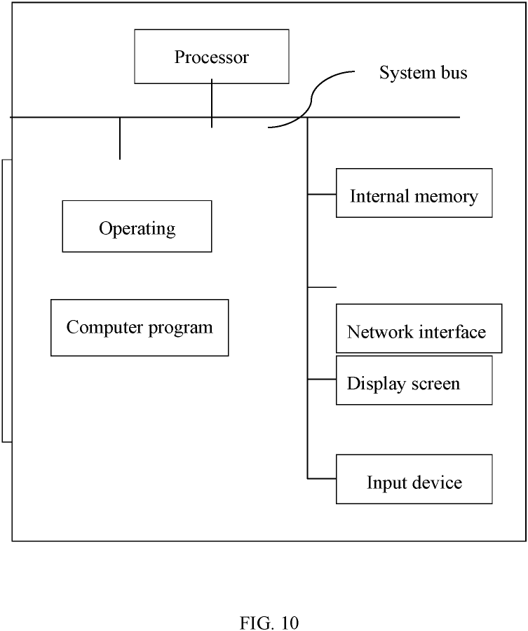

In another embodiment of the present invention, as shown in FIG. 10, an electronic device is provided, which includes a processor and a memory; a computer program is stored in the memory, and when the processor executes the computer program, the control method of the flashing color lamps is implemented.

It can be understood by those skilled in the art that the structure shown in FIG. 10 is only a block diagram of a part of the structure related to the solution of the present application, and does not constitute a limitation on the electronic device to which the solution of the present application is applied. The specific electronic device may include more or less components than those shown in the figure, or combine some components, or have different component arrangements.

In another embodiment of the present invention, a computer-readable storage medium is provided, on which a computer program is stored; the computer program, when executed by a processor, implements the control method of the above-mentioned flashing color lamps.

Those skilled in the art can understand that all or part of the processes in the method for realizing the above-mentioned embodiments can be completed by instructing related hardware through a computer program, which can be stored in a nonvolatile computer-readable storage medium, and when executed, the computer program can include the processes of the above-mentioned embodiments. Among them, any reference to memory, storage, database or other media used in the embodiments provided in this application may include non-volatile and/or volatile memory. The nonvolatile memory may include read-only memory (ROM), programmable ROM(PROM), electrically programmable ROM(EPROM), electrically erasable programmable ROM(EEPROM) or flash memory. The volatile memory may include random access memory (RAM) or external cache memory. By way of illustration and not limitation, RAM is available in various forms, such as static RAM(SRAM), dynamic RAM(DRAM), synchronous DRAM(SDRAM), double data rate SDRAM(DDRSDRAM), enhanced SDRAM(ESDRAM), synchronous link DRAM (SLDRAM), memory bus (Rambus) direct RAM(RDRAM), direct memory bus dynamic RAM(DRDRAM), and memory bus dynamic RAM(RDRAM), etc.

The technical means disclosed in the solution of the present invention are not limited to the technical means disclosed in the above embodiments, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A method for controlling flashing color lamps, comprising
establishing a first virtual model according to a physical layout form of the flashing color lamps to be controlled, wherein the first virtual model is configured for controlling the flashing color lamps to flash; wherein the method further comprises:
a, presetting a color sequence for the first virtual model, and generating a flashing color lamp control instruction according to the color sequence, wherein the flashing color lamp control instruction is configured for controlling the flashing color lamps to flash in a preset flashing frame;
b, acquiring a real-time flashing image of the flashing color lamps when flashing in the preset flashing frame to generate a real-time flashing picture of the flashing color lamps;
c, extracting an actual flashing color in the real-time flashing picture of the flashing color lamps to generate a real-time flash frequency color sequence of the flashing color lamps;
d, generating actual spatial positions of the flashing color lamps and establishing a second virtual model based on the preset color sequence and the real-time flash frequency color sequence;
e, correcting the first virtual model with the second virtual model, so that the spatial positions of the virtual flashing color lamps in the first virtual model correspond to the spatial positions of the flashing color lamps in the physical layout form one by one;
acquiring the flashing color lamp control instruction which triggers the first virtual model and sending the flashing color lamp control instruction to the flashing color lamps to be controlled, wherein the flashing color lamp control instruction is configured for controlling the flashing color lamps to be controlled to do actions matched with the flashing color lamp control instruction.

2. The method for controlling flashing color lamps according to claim 1, wherein,
the step of establishing a first virtual model according to a physical layout form of the flashing color lamps to be controlled specifically comprises the following steps:
respectively presetting different color sequences are according to the flashing color lamps;
generating a real-time color flashing sequence according to different color sequences;
generating a flashing control instruction according to the real-time color flashing sequence, wherein the flashing control instruction is configured for controlling each flashing color lamp to flash in the preset flashing frame.

3. The method for controlling flashing color lamps according to claim 2, wherein,
the step of establishing a first virtual model according to a physical layout form of the flashing color lamps to be controlled specifically comprises the following steps:
adjusting the preset flashing frame according to the physical layout form of the flashing lamps, and the flashing lamps corresponding to different real-time flashing pictures of flashing lamps when flashing with different preset flashing frames.

4. The method for controlling flashing color lamps according to claim 3, wherein,
the step of establishing a first virtual model according to a physical layout form of the flashing color lamps to be controlled specifically comprises the following steps:
each flashing color lamp having a real-time flashing color and a space position in the real-time flashing picture of the flashing color lamps; and
generating the real-time flash frequency color sequence of flashing color lamps according to the real-time flashing colors and spatial positions of the flashing color lamps in different periods.

5. The method for controlling flashing color lamps according to claim 1, wherein,
after the step of establishing a first virtual model according to a physical layout form of the flashing color lamps to be controlled, the method further comprises:
acquiring pre-stored flashing effect data of the flashing color lamps;
generating a second control instruction according to the flashing effect data of the flash color lamps, and sending the second control instruction to the flash color lamps to be controlled, wherein the second control instruction is configured for control the flash color lamps to flash with an effect matched with the flashing effect data of the flash color lamps.

6. The method for controlling flashing color lamps according to claim 1, wherein,
after the step of establishing a first virtual model according to a physical layout form of the flashing color lamps to be controlled, the method further comprises:
acquiring flashing color lamp custom special effect data that has been set;
generating a third control instruction according to the flashing color lamp custom special effect data, and sending the third control instruction to the flashing color lamps to be controlled, wherein the third control instruction is configured for controlling the flashing color lamps to flash with an effect matched with the flashing effect data of the flash color lamps.

7. An apparatus for controlling flashing color lamps, which is applied to electronic device, wherein
the apparatus for controlling flashing color lamps comprises:
a model establishing module configured for establishing a first virtual model according to a physical layout form of the flashing color lamps to be controlled, wherein the first virtual model is configured for controlling the flashing color lamps to flash, comprising:
a, presetting a color sequence for the first virtual model, and generating a flashing color lamp control instruction according to the color sequence, wherein the flashing color lamp control instruction is configured for controlling the flashing color lamps to flash in a preset flashing frame;
b, acquiring a real-time flashing image of the flashing color lamps when flashing in the preset flashing frame to generate a real-time flashing picture of the flashing color lamps;
c, extracting an actual flashing color in the real-time flashing picture of the flashing color lamps to generate a real-time flash frequency color sequence of the flashing color lamps;
d, generating actual spatial positions of the flashing color lamps and establishing a second virtual model based on the preset color sequence and the real-time flash frequency color sequence;
e, correcting the first virtual model with the second virtual model, so that the spatial positions of the virtual flashing color lamps in the first virtual model correspond to the spatial positions of the flashing color lamps in the physical layout form one by one;
a flashing color lamp control module configured for acquiring the flashing color lamp control instruction which triggers the first virtual model and sending the flashing color lamp control instruction to the flashing color lamps to be controlled, wherein the flashing color lamp control instruction is configured for controlling the flashing color lamps to be controlled to do actions matched with the flashing color lamp control instruction.

8. An electronic device comprising a processor and a memory, wherein,
the memory stores a computer program, and when the processor executes the computer program, the following methods can be implemented:
establishing a first virtual model according to a physical layout form of the flashing color lamps to be controlled, wherein the first virtual model is configured for controlling the flashing color lamps to flash, comprising:
a, presetting a color sequence for the first virtual model, and generating a flashing color lamp control instruction according to the color sequence, wherein the flashing color lamp control instruction is configured for controlling the flashing color lamps to flash in a preset flashing frame;
b, acquiring a real-time flashing image of the flashing color lamps when flashing in the preset flashing frame to generate a real-time flashing picture of the flashing color lamps;
c, extracting an actual flashing color in the real-time flashing picture of the flashing color lamps to generate a real-time flash frequency color sequence of the flashing color lamps;
d, generating actual spatial positions of the flashing color lamps and establishing a second virtual model based on the preset color sequence and the real-time flash frequency color sequence;
e, correcting the first virtual model with the second virtual model, so that the spatial positions of the virtual flashing color lamps in the first virtual model correspond to the spatial positions of the flashing color lamps in the physical layout form one by one;
a flashing color lamp control module configured for acquiring the flashing color lamp control instruction which triggers the first virtual model and sending the flashing color lamp control instruction to the flashing color lamps to be controlled, wherein the flashing color lamp control instruction is configured for controlling the flashing color lamps to be controlled to do actions matched with the flashing color lamp control instruction.

9. A computer-readable storage medium having a computer program stored thereon, wherein,
the computer program, when executed by a processor, can implement the following methods:
establishing a first virtual model according to a physical layout form of the flashing color lamps to be controlled, wherein the first virtual model is configured for controlling the flashing color lamps to flash, comprising:
a, presetting a color sequence for the first virtual model, and generating a flashing color lamp control instruction according to the color sequence, wherein the flashing color lamp control instruction is configured for controlling the flashing color lamps to flash in a preset flashing frame;
b, acquiring a real-time flashing image of the flashing color lamps when flashing in the preset flashing frame to generate a real-time flashing picture of the flashing color lamps;
c, extracting an actual flashing color in the real-time flashing picture of the flashing color lamps to generate a real-time flash frequency color sequence of the flashing color lamps;
d, generating actual spatial positions of the flashing color lamps and establishing a second virtual model based on the preset color sequence and the real-time flash frequency color sequence;
e, correcting the first virtual model with the second virtual model, so that the spatial positions of the virtual flashing color lamps in the first virtual model correspond to the spatial positions of the flashing color lamps in the physical layout form one by one;
a flashing color lamp control module configured for acquiring the flashing color lamp control instruction which triggers the first virtual model and sending the flashing color lamp control instruction to the flashing color lamps to be controlled, wherein the flashing color lamp control instruction is configured for controlling the flashing color lamps to be controlled to do actions matched with the flashing color lamp control instruction.
